(19) United States
(12) Patent Application Publication
(10) Pub. No.: US 2019/0361767 A1
(43) Pub. Date: Nov. 28, 2019

(54) AUTOMATICALLY REACTING TO DATA INGEST EXCEPTIONS IN A DATA PIPELINE SYSTEM BASED ON DETERMINED PROBABLE CAUSE OF THE EXCEPTION

(71) Applicant: Microsoft Technology Licensing, LLC, Redmond, WA (US)

(72) Inventors: Swetha Karthik, Sunnyvale, CA (US); Yi Zhang, Sunnyvale, CA (US)

(21) Appl. No.: 15/988,521

(22) Filed: May 24, 2018

(51) Int. Cl. G06F 11/07; G06F 11/14; H04L 12/24

(52) U.S. Cl. CPC G06F 11/0781; G06F 11/0769; H04L 41/5074; G06F 11/0793; G06F 11/1469; G06F 11/0784

(57) ABSTRACT

The techniques herein include an exception handler determining whether filtering criteria have been met for providing notification of an exception generated by a data ingest component in a data pipeline system to an exception analyzer. In response to determining that the filtering criteria is satisfied, the notification is provided to an exception analyzer. The exception analyzer analyzes the exception and selects a first reaction for an exception remediator to perform to attempt to recover from the exception based on the analysis. The chosen reaction may include automatically rolling back the data ingest component to a prior known stable software version, fixing source data ingested by the data ingest component, creating a troubleshooting ticket in a troubleshooting ticketing system, sending an electronic message to troubleshoot personnel, and the like. The reaction is then performed.

### TECHNICAL FIELD

The present disclosure relates generally to data pipeline computer systems. In particular, the present disclosure relates to automatically reacting to data ingest exceptions in a data pipeline system based on determined probable cause of the exception.

### BACKGROUND

In data pipeline systems, and especially in situations where data ingest components of the systems undergo agile or rapid application development (such as by teams of software developers of an online service responding to new feature requirements with iterative changes to software components of the system), errors in data ingest components can occur when ingesting the data produced by data producing components in the system, sometimes causing a programmatic runtime exception to be raised. This causes a number of issues. First, detecting the root cause of the error can be a problem. For example, it can be difficult and time consuming to determine whether the error was caused by a programming error (i.e., “bug”) in the data ingest component, whether the error was caused by a data formatting error in the ingested data, and/or whether the error was caused by a programming error/bug in the data producing component. Meanwhile, the error may continue to occur. Second, remediating the error can be costly. Many expensive highly-skilled person-hours may be required to detect the root cause of the error and remediate it. Third, the error can negatively affect online service revenue. For example, if the error occurs in a data ingest component that supports serving paid-for advertisements, then the online service may lose revenue resulting from over or under serving advertisements because of the error. Combined together, these issues make it impossible to apply agile or rapid application development methodologies to the development of data pipeline systems in a time and cost-effective manner, since the automation for error remediation is lacking.

The techniques described herein address these and other issues.

The approaches described in this section are approaches that could be pursued, but not necessarily approaches that have been previously conceived or pursued. Therefore, unless otherwise indicated, it should not be assumed that any of the approaches described in this section qualify as prior art merely by their inclusion in this section.

### SUMMARY

The attached claims serve as a summary of the invention.

### BRIEF DESCRIPTION OF THE DRAWINGS

In the drawings:

FIG. 1 depicts an example process for automatically reacting to data ingest exceptions in a data pipeline system based on determined probable cause of the exception.

FIG. 2 depicts an example system for automatically reacting to data ingest exceptions in a data pipeline system based on determined probable cause of the exception.

FIG. 3 depicts example hardware for automatically reacting to data ingest exceptions in a data pipeline system based on determined probable cause of the exception.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form to avoid unnecessarily obscuring the present invention.

### General Overview

Automatic reaction to data ingest exceptions based on determined probable cause of the exception is an important issue for electronic systems, including data pipeline computer systems. Consider, for example, an online service that generates revenue by serving paid-for advertisements. Maximizing advertisement serving revenue involves preventing both under-serving and over-serving advertisements with respect to the number of advertisements (impressions) that a customer has paid for. With under-serving, the customer received less than they paid for. With over-serving, the customer received more than they paid for. In either case, the online service may incur lost revenue.

Over and under-serving may be caused by data ingest errors in a data pipeline system. The online service may use the data pipeline system, for example, to move data reflecting changes to customers' advertising accounts held with the online service to the online service's advertisement serving system. The advertisement system may select and serve advertisements to online users of the online service. Data ingest components of the data pipeline system may, for example, ingest the account change data for purposes of configuring the advertisement system in accordance with the change. For example, account change data may reflect an increase to a particular customer's advertising budget with the online service. If the account change data is not formatted properly or if there is a programming bug in the data ingest component, then a data ingest error may occur when the account change data is ingested by the data ingest component. The result being that the advertisement system is not configured correctly, potentially causing the system to over or under serve advertisements for the customer. The longer the advertisement system remains configured incorrectly, the longer the advertisement system may over or under serve advertisements for the customer, and the greater the loss in revenue to the online service.

Techniques described herein address these and other issues.

It should be noted that while the techniques disclosed herein can be implemented to prevent over and under serving of advertisements in an online service that serves paid-for advertisements to users of the online service, the techniques disclosed herein are not limited to that context and may be implemented in any data pipeline system having data ingest components that generate exceptions caused by programming errors in data producing components or the data ingesting components or formatting errors in the ingested data.

Using the techniques herein, programmatic runtime exceptions are caught by exception handlers of data ingest components. These runtime exceptions can be of various data types/object-oriented classes including base exception types/classes (e.g., NullPointerException, NumberFormatException, IllegalArgumentException, RuntimeException, etc.) and user-defined exception types (e.g., a sub-type or sub-class of a base exception type/class). The base exception types/classes may be those provided by standard libraries of the particular computer programming language (e.g., Java, Python, etc.) used to implement the data ingest component. The user-defined exception types may be those programmed by a programmer of a data ingest component based on the standard libraries of the particular computer programming language used.

Once an exception is caught by an exception handler of a data ingest component, an exception analyzer may analyze the exception to determine a probable cause of the exception. The exception analyzer may also determine the probable cause based on available metadata about the exception, such as the particular data ingest component that generated the exception, the particular data being ingested when the exception occurred, the particular data producing component that produced the particular data being ingested, past reactions to exceptions like the exception that occurred (e.g., past exceptions of the same type, from by same data ingest component, etc.), results of the past reactions (e.g., successful recovery, unsuccessfully recovery, etc.), and other possible exception metadata.

Based on the analysis of the exception, the exception analyzer may select a reaction for an exception remediator to perform to attempt to recover from the exception. For example, if the probable cause of the exception is a programming error in the particular data ingest component, the exception remediator may automatically roll back the particular data ingest component to a prior version or a prior known stable version of the particular data ingest component. A prior known stable version may be a version of the data ingest component that operated in a production environment without a significant incident. For example, a significant incident may be an exception generated by a current version of a data ingest component that caused the data ingest component to be rolled back (reverted) to a prior known stable version of that data ingest component. In contrast, an exception generated with a probable cause of a data formatting error in ingested data may not be a significant incident for this purpose because the probable cause of the exception was a data formatting error and not a programming error in the data ingest component.

As another example, the reaction may be to create a troubleshooting ticket in a troubleshooting ticketing system. For example, if the probable cause of the exception is a data formatting error in the particular data ingested, then the troubleshooting ticket may be created for the team responsible for the data source of the particular data ingested or the team responsible for the data producing component that produced the particular data ingested. Numerous other examples of reactions are discussed herein.

### Example Process

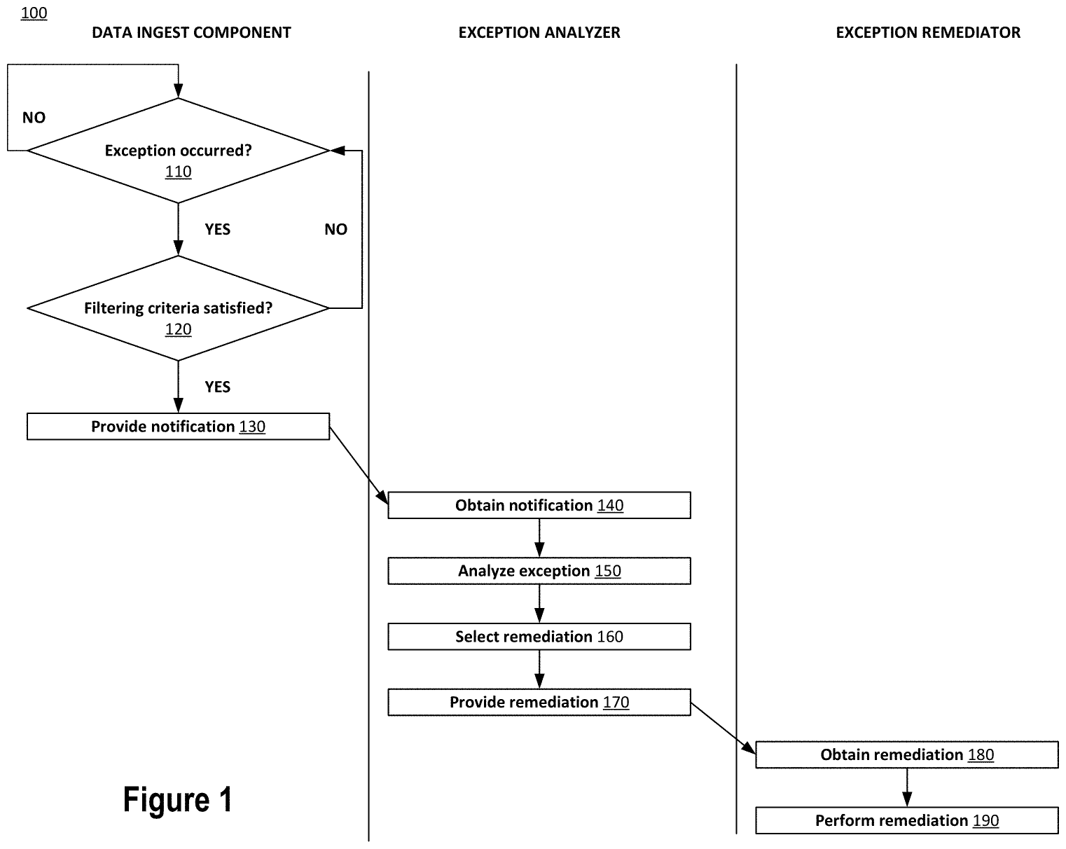

FIG. 1 depicts a process 100 for automatically reacting to data ingest exceptions in a data pipeline system based on determined probable cause of the exception. The process 100 begins by a data ingest component in the data pipeline system determining whether a programmatic runtime exception has occurred 110. If so, then the process 100 continues with the data ingest component determining whether filtering criteria is satisfied 120 for sending a notification of the exception to the exception analyzer. If an exception has not occurred, then the process 100 waits until one does occur. If the filtering criteria is not satisfied, then the process 100 waits until another exception occurs. The filtering criteria may encompass various factors, as discussed herein. If the filtering criteria has been met, then a notification of the exception is provided 130. The exception analyzer obtains the notification 140 and analyzes the exception 150. Based on the analysis, the exception analyzer selects a reaction to the exception 160. Once selected, the reaction is provided to the exception remediator 170. The exception remediator obtains 180 and performs 190 the reaction.

### Determining Whether an Exception has Occurred

Returning to the top of process 100, the data ingest component determines whether a programmatic runtime exception has occurred 110. Generally, a programmatic runtime exception is an event that occurs during the execution of data ingest component that disrupts the normal program flow of the data ingest component. Depending on the programming language used to implement the data ingest component (e.g., Java), the exception may be instantiated as an object that wraps an error event that occurred within the data ingest component. The object may contain information about the error including its type/class (e.g., the error or exception type or the object's object-orientated class name), the state of the data ingest component execution when the error occurred, and other information. Exceptions can be thrown and caught. In particular, after an exception object is created, it is “thrown” to the runtime system (e.g., Java VM) for handling by the runtime system. The runtime system attempts to find a handler for the exception by backtracking the call stack. If a handler if found, then the exception is caught where it is handled or possibly re-thrown. If a handler is not found, then the data ingest component aborts execution.

In some embodiments, the determination of whether a programmatic runtime exception has occurred 110 is made by a global exception handler of the data ingest component. The global exception handler may be configured to catch all programmatic runtime exceptions generated by the data ingest component that are not caught and handled internally by the application component of the data ingest component. In this regard, the data ingest component may be composed of two general sub-components: an “application” component and a “global exception handling” component. The application component implements the particular functionality of the data ingest component. The particular functionality may vary from data ingest component to data ingest component. For example, the application component of one data ingest component may consume and process advertising account budget changes. While the application component of another data ingest component may provision a new advertising account.

The application component of the data ingest component may be linked to or otherwise programmatically combined statically (e.g., at compile time) or dynamically (e.g., at runtime) with the global exception handling component. From a software development perspective, the application component and the global exception handling component may be developed separately (e.g., by different software teams) as combinable libraries that are linked or programmatically combined to form the data ingest component. In this way, the global exception handling component may be combined and reused with different application components in different data ingest components. Thus, the global exception handling component may be common to multiple data ingest components even though the application components of the multiple data ingest components differ.

The global exception handling component may be configured to catch any uncaught programmatic runtime exceptions generated by the application component that it is combined with. It may do this with a programmatic exception handler that encompasses an execution entry point (e.g., function call) to the application component of the data ingest component such that the exception handler is above the execution entry point in the call stack. In this way, any exception that is generated below the execution entry point in the call stack that is not handled by the application component can be caught and handled by the encompassing exception handler of the global exception handling component.

An uncaught exception generated by the application component can include an exception that is not caught by the application component or an exception that is caught by the application component but then rethrown by the application component where the rethrown exception is not caught by the application component. All such uncaught exceptions may be caught by the global exception handling component and then processed by the global exception handling component. This processing may include determining whether filtering criteria is satisfied 120 for sending a notification of the exception to the exception analyzer and providing a notification of the exception 130 to the exception analyzer if the filtering criteria is satisfied. Because the global exception handling component is configured to perform these operations 110, 120, and 130, the application component need not be configured to do so. In this way, development of the application component is simplified and automatic reaction to the exception may be delegated by the application component to the global exception handling component, which can be leveraged across different application components of different data ingest components.

### Determining Whether Filtering Criteria is Satisfied

Continuing with process 100, the global exception handling component of the data ingest component determines whether filtering criteria for providing notification of the exception to the exception analyzer is satisfied 120. The global exception handling component may make this determination for an exception not caught by the application component of the data ingest component but that is caught by the global exception handling component. The filtering criteria may include various factors.

In some embodiments, the filtering criteria is provided by the application component of the data ingest component to the global exception handling component of the data ingest component. In this case, the filtering criteria may be provided by application component to the global exception handling component to configure which exceptions the global exception handling component will provide notification of to the exception analyzer. For example, the filtering criteria may specify a set (list) of exception types/classes for which the global exception handler is to provide notification to the exception analyzer. If the global exception handler component catches an exception having a type/class in the set, then the global exception handler notifies the exception analyzer of the exception. If the caught exception is not in the set, then the global exception handler can be configured to rethrow the exception (thereby causing the data ingest component to abort exception), log the exception, or perform some other action (e.g., ignore the exception). Note that the global exception handler may log all exceptions it catches regardless if a notification for an exception is provided to the event analyzer.

In some embodiments, there may be integration with a logging application for exceptions. The logging integration may allow the techniques herein to use logged exceptions as filtering criteria for sending a notification of a particular exception to the exception analyzer. For example, if a previous occurrence of the particular exception has just occurred in the data ingest component (as indicated by a log entry indicating the type/class of the particular exception, an identifier of the data ingest component, and a time of the prior occurrence of the particular exception), then the global exception handler could determine that the filtering criteria have been met 120 by determining that the time of the prior occurrence of the particular exception type/class in the data ingest component is within a threshold amount of time of the current occurrence of the particular exception type/class in the data ingest component.

In some embodiments, the log entry may indicate a number of occurrences or frequency of occurrences of the particular type/class of exception in the data ingest component (e.g., by counting log entries for exceptions of the particular type/class in the data ingest component that occurred within a window of time, such as past hour, past 24-hours, past week, etc.), and the number of occurrences or the frequency of occurrences being above a threshold may indicate that the filtering criteria have been met 120. Once the threshold is exceeded, then the exception analyzer may be notified about occurrences of the particular type/class of exception in the data ingest component. In some embodiments with logging integration, the filtering criteria may be met when there are other types of log entries: same type/class of exception for different data ingest components (e.g., by matching the type/class of the particular exception being handled to other log entries irrespective of the data ingest component identified in the log entries), same type/class of exception for similar data ingest components (e.g., by matching the type/class of particular exception being handled to other log entries associated with a data ingest component that belongs to a group of data ingest components to which the particular data ingest component that generated the particular exception also belongs), and the like.

For example, filtering criteria could be met 120 when an exception occurs with respect to a previous exception. For example, if a data ingest component has previously been associated with an exception and a particular probable cause (e.g., code error), then a follow up to that previous exception may be warranted. As such, if and when a next exception for the particular exception occurs, the filtering criteria may be met 120. Taking the example further, if the reaction performed for the previous occurrence of the particular exception was to roll back the data ingest component to a prior version, then if the particular exception occurs again, then the filtering criteria may be met 120.

In this description, reference is made to filtering criterion where a number of exceptions or a number of exceptions of a particular type/class during a period of time exceeds a threshold. It is also possible to use a filtering criterion that is based on the number of exceptions or the number of exceptions of a particular type/class during a period of time such as, for example, a suitable statistic derived from these numbers such as, for example, an average, mean, median, etc.

In some embodiments, the filtering criteria may be related to a previous event, interaction, or the like, regardless of any previously determined probable cause. For example, if a user opens a ticket when an error or exception occurs in a data ingest component in a ticket or issue management system, then the filtering criteria may be met 120 when an exception occurs in the data ingest component that is the subject of the open ticket or when an exception of the same type or class that is the subject of the open ticket occurs. As another example, when a subsequent log entry related to the previous event, interaction, etc. is added to the log, then the filtering criteria may be met 120. For example, the filtering criteria may be associated with the addition of log entries associated with a particular data ingest component, such as log entries recording the occurrence of certain exceptions in the particular data ingest component. As such, filtering criteria may be met after each such log entry.

Filtering criteria may be met 120 at some frequency related to a data ingest component execution. For example, filtering criteria may be met once a threshold number of exceptions of a certain type/class have occurred in the data ingest component during the execution, after a threshold number of exceptions of a certain type/class have occurred within a sliding window of time of a predetermined length (e.g., one hour, one day, one week, etc.), after the ratio of the number of exceptions per data pipeline messages successfully processed by the data ingest component exceeds a threshold, randomly among exceptions, the first exception that occurs after an update in version to the data ingest component (e.g., the first exception after an upgrade to the applicant component of the data ingest component), and the like. Relatedly, in embodiments with ticketing system integration, when a ticket is opened about a particular exception type/class and/or a particular data ingest component (e.g., if the exception type/class or data ingest component identifier is detected in the ticket entry), the filtering criteria may be met 120 for any exception occurring of that particular type/class and/or in that particular data ingest component.

In some embodiments, filtering criteria may be related to exceptions in other, related data ingest components. For example, the filtering criteria may be met 120 when one or more other data ingest components associated with a particular data ingest component (e.g., as members of the same group) generate exceptions. For example, the filtering criteria may be met 120 when the number of exceptions of a specified type/class that occur across all data ingest components in the group exceeds a threshold.

In each of the above-discussed determined meeting 120 of filtering criteria, the time of day may also be one of the criteria. For example, notifications of exceptions might only be provided during off-hours (e.g., between midnight and 6 am local time). As such, if other criteria have been met (e.g., exception type/class matches target type/class), the filtering criteria may not be met until the off-hours of those criteria, at which time notification of an exception may be provided.

In some embodiments, the data center hosting the data ingest component may be used as criteria. For example, exceptions generated in data ingest components hosted in the San Francisco data center may satisfy filtering criteria (assuming the other filtering criteria is also satisfied) while exceptions occurring in data ingest components hosted in the New York data center may not satisfy the filtering criteria (even if the exceptions satisfy all other filtering criteria).

In some embodiments, a user can request a notification for an exception be provided to the exception analyzer. For example, a user could select a setting, press a button on a webpage, or the like. This action may indicate that the filtering criteria has been met 120 for a selected exception. Relatedly, in some embodiments, a user can respond to an alert or inquiry about an exception to confirm that a notification about the exception should be sent to the exception analyzer. For example, a user may log into his or her user account, and, from there, find (e.g., on a webpage or in a page in a user application) an alert or inquiry about an exception that occurred in a data ingest component (e.g., on a web page), and confirm that a notification about the exception should be provided to the exception analyzer (e.g., by selecting a “confirm” or “send notification” button associated with the exception on a web page). Once confirmed by the user, the exception analyzer could receive the notification.

### Analyzing the Exception

If the filtering criteria have been met 120 for an exception, then the notification of the exception is provided 130. The technology and protocols used to provide the notification may be any appropriate set, and the notification will typically be provided using a methodology agreeable or usable by the sender (e.g., the global exception handler component of a data ingest component) and recipient (e.g., the exception analyzer). The notification protocol can include a variety of technologies including e-mail, HTTP(S), SSL, SSH, TCP/IP, etc.

Once the notification of an exception is obtained 140 by the exception analyzer, the exception analyzer then analyzes 150 the exception that is the subject of the notification.

In some embodiments, the notification includes structured data (e.g., XML or JSON structured data or the like) about the exception, such as an identifier of the particular data ingest component that generated the exception, a time of the exception occurrence, the particular data being ingested when the exception occurred, the particular data producing component that produced the particular data being ingested when the exception occurred, the particular type/class of the exception, the number of times the particular type/class of the exception has occurred during the current execution of the particular data ingest component, and the like. In such embodiments, there may be probable cause analysis performed on the exception. In some embodiments, the exception analyzer uses exception type/class matching to analyze the exception. For example, the probable cause can be determined by classifying the exception into “code error” or “data error” based on the type/class of the exception. For example, an exception of type/class “DataFormatException” (or a sub-type/sub-class thereof) or “IllegalFormatException” (or a sub-type/sub-class thereof) may be classified as “data error” while other types/classes of exceptions may be classified as “code error.”

In some embodiments, the exception analyzer matches code error and data error aspects of the exception and makes a determination of whether the probable cause of the exception is a code error or a data error based at least in part on the balance of code error and data error aspects. For example, the exception analyzer may perform probably cause analysis as a binary classification task, where each of one or more of the following aspects of an exception is given a score that is code error (1), data error (0), or ignored (alternatively, data error (1), code error (0), or ignored). The probable cause of the exception may then be a function of that data error and code error classification (e.g., an average of the scores where, if the average is above some threshold, such as 0.50, then the exception is considered a code error).

More fine-grained probable cause determinations are also possible. For example, as well as determining that the probable cause of an exception is a data error, it may also be determined by the exception analyzer that the probable cause of the data error is, for example, a missing field in the ingested data or an incompatible or unexpected data type in the ingested data, etc. As another example, as well as determining that the probable cause of an exception is a code error, it may also be determined by the exception analyzer that the probable cause of the code error is, for example, a parsing instruction or set of instructions operating on the ingested data, a data type cast or conversion instruction or set of instructions operating on the ingested data, etc.

Some aspects of an exception that may be classified according to a binary classifier as code error or data error are:
the type/class of the exception;
a time of the exception occurrence,
the data ingest component that generated the exception, and
the data producing component that produced the data being ingested when the exception occurred.

In some embodiments, the exception analyzer uses supervised machine learning to analyze 150 the probable cause of the exception. With supervised machine learning, training data has aspects of previous exceptions with cause labels (e.g., code error, data error, and optionally ignore). A neural network is trained with the training data. Subsequently, the exception analyzer can use the trained neural network to determine the probable cause of the exception.

In some embodiments, if a mistake or error is noted in the determination of probable cause (e.g., an exception is determined to be caused by a code error by the exception analyzer, and a human operator later determines that the determined probable cause was incorrect), the exception analyzer may add the exception and the corrected cause to the training data. This will allow the neural network to be retrained and correct the previous error.

Numerous types of machine learning algorithms may be used to create probable cause classifiers. In some embodiments, a multinomial logistic regression (softmax regression) is used. In these embodiments, for a given exception instance x, a softmax score sₖ(x) is computed for each possible class (e.g., code error, data error, ignore) according to a softmax score function. The probability of the exception instance x belonging to each possible class is computed by applying a softmax function to the softmax scores.

In some embodiments, the softmax score for a class k where k is one of {data error, code error, or ignore} is computed for the exception instance x according to the following softmax score function:

sₖ(x)=θₖ^{T}·x

Each class may have its own dedicated parameter vector θₖ which may be stored as rows in a parameter matrix.

In some embodiments, the estimated probability that the exception instance x belongs to a class k where the k is one of {data error, code error, or ignore} given the softmax scores of each possible class for the exception instance x is computed according to the following softmax function.

$${\hat{p}}_{k} = {σ ( s ( x ) )}_{k} = \frac{exp ( {s}_{k} ( x ) )}{{\sum }_{j = 1}^{K} exp ( {s}_{j} ( x ) )}$$

The above softmax function (normalized exponential) computes the exponential of every softmax score, then normalizes the exponentials by dividing by the sum of all of the exponentials. Here, the parameter K is the number of classes (e.g., three). The parameter s(x) is a vector containing the softmax scores for each class for the exception instance x. The parameter σ(s(x)) is the estimated probability that the exception instance x belongs to class k given the softmax scores of each class for that exception instance x.

The class with the highest estimated probability (i.e., the class with the highest softmax function score) may be the class selected for the exception instance x.

The above multinomial logistic regression model may be used to estimate probabilities of a given exception instance x belonging to different classes representing different probable causes of the given exception, as well as making a prediction of the most likely probable cause of the given exception. The model may be trained to estimate a high probability for a target class (label) and consequently a low probability for the other classes by minimizing a cost function applied to a training set. In some embodiments, the cross entropy is used as the cost function. Cross entropy can be effective at measuring how well a set of estimated class probabilities match the target classes. For example, the following cross entropy cost function may be used to train the model:

$$J ( Θ ) = - \frac{1}{m} {\sum }_{i = 1}^{m} {\sum }_{k = 1}^{K} {y}_{k}^{( i )} log ( {\hat{p}}_{k}^{( i )} )$$

Here, the parameter m is the number of training examples in the training set. The parameter i refers to i^{th} training example in the training set. The parameter uppercase K refers to the number of target classes (e.g., three). The parameter lowercase k refers to the k^{th} class. The parameter yₖ⁽ⁱ⁾ is equal to one (1) if the target class (label) for the i^{th} instance is k. Otherwise, it is equal to zero (0).

The parameter Θ is the parameter matrix that minimizes the cost function over the training set. The parameter matrix Θ is composed of parameter vectors stored as rows in the parameter matrix Θ, one parameter vector for each target class. To compute the parameter matrix Θ that minimizes the cross entropy cross function, a gradient vector may be computed for each distinct target class. Then gradient descent or other optimization algorithm may be used to compute the parameter matrix Θ. The gradient vector of the cross-entropy cost function with regards to the parameter vector θₖ for a given class k may be computed according to the following formula:

$${∇}_{{θ}_{k}} J ( Θ ) = \frac{1}{m} {\sum }_{i = 1}^{m} ( {\hat{p}}_{k}^{( i )} - {y}_{k}^{( i )} ) {x}^{( i )}$$

Multinomial logistic regression extends standard binary logistic regression to multiple possible discrete outcomes. Thus, one skilled in the art will appreciate that the above logistic regression model can be used when there are only two target classes (e.g., code error and data error.) In some embodiments, the possible discrete outcomes are code error, data error, and possible unknown error as a third possible outcome. In some embodiments, the classification of probable cause is accomplished with perceptrons, support-vector machines (SVMs), random forests, and/or a type of neural network, including a recurrent or convolutional neural network.

Regardless of the type of multinomial classifiers used (e.g., multinomial logistic regression, multinomial Naïve bayes, etc.), the training data may have numerous examples of each probable cause. Below is a table of some examples of code error, data error, and ignore probable causes for data ingest exceptions. Here, each training data item is composed of three features (independent variables) of a corresponding data ingest exception: (1) the exception type/class, (2) an identifier of the data ingest component, and (3) an identifier of the data producing component that produced the data ingested by the data ingest component when the exception occurred. The techniques described herein apply to and can be used with different feature sets including a subset of the features below or a superset thereof

| | | Data Ingest | Data Producing |
|---|---|---|---|
| Probable | | Component ID | Component ID |
| Cause | Exception Type/Class (Independent | (Independent | (Independent |
| (Label) | Variable #1) | Variable #2) | Variable #3) |
| Data Error | java.lang.RuntimeException | 0xc4 | 0x40 |
| Code Error | java.lang.ReflectiveOperationException | 0xa5 | 0x23 |
| Data Error | java.lang.NullPointerException | 0x95 | 0x85 |
| Code Error | java.lang.illegalStateException | 0xbf | 0x8e |
| Ignore | java.lang.RuntimeException | 0x26 | 0x87 |
| Data Error | Java.lang.NumberFormatException | 0x12 | 0x69 |
| Code Error | java.lang.ReflectiveOperationException | 0x04 | 0xe2 |

After training a supervised machine learning model (e.g., a neural network or a multinomial logistic regression model), the exception analyzer analyzes 150 incoming exception notifications, such as the following:

| | | Data | |
|---|---|---|---|
| | Data Ingest | Producing | Determined |
| | Component | Component | Probable |
| Exception Type/Class | ID | ID | Cause |
| java.lang.ReflectiveOperationException | 0x56 | 0x23 | Code Error |
| java.lang.NumberFormatException | 0x95 | 0x85 | Data Error |
| java.lang.ClassCastException | 0xbf | 0x8e | Code Error |
| java.lang.RuntimeException | 0x90 | 0x09 | Ignore |
| Java.lang.NumberFormatException | 0x2a | 0x69 | Data Error |
| java.lang.ClassNotFoundException | 0x04 | 0xe2 | Code Error |

### Selecting and Performing the Reaction

Based on the analysis 150 of the exception, the exception analyzer chooses and selects 160 a reaction to the exception for the exception remediator to perform based on the determined probable cause. Once a reaction is selected 160, it may be provided 170 to the exception remediator. Once the exception remediator obtains 180 the reaction, it may perform it 190. The technology and protocols used to provide 170 and obtain 180 the remediation may be any appropriate, including those used to provide 130 and obtain 140 the exception notification.

In some embodiments, the reaction selected 150 can be one or more of the following, or a subset or a superset thereof:
automatically rolling back the particular data ingest component to a prior software version,
creating a troubleshooting ticket for the exception in a troubleshooting ticketing system,
generating an alert for the exception using an alert generation system, and
sending an electronic message about the exception to troubleshooting personnel.

In some embodiments, if the exception analyzer determines that the probable cause of the exception is a code error, then the exception analyzer may select a reaction that includes automatically rolling back the particular data ingest component to a prior software version of the particular data ingest component (or the application component thereof).

In some embodiments, if the exception analyzer determines that the probable cause of the exception is a code error or a data error, then the exception analyzer may select a reaction that includes creating a troubleshooting ticket for the exception in a troubleshooting ticketing system. The troubleshooting ticket created may indicate the probable cause (i.e., code error or data error) to jumpstart the troubleshooting process.

In some embodiments, if the exception analyzer determines that the probable cause of the exception is a code error or a data error, then the exception analyzer may select a reaction that includes generating an alert for the exception using an alert generation system. The alert generated created may indicate the probable cause (i.e., code error or data error) to jumpstart the troubleshooting process.

In some embodiments, if the exception analyzer determines that the probable cause of the exception is a code error or a data error, then the exception analyzer may select a reaction that includes sending an electronic message about the exception to troubleshooting personnel. The electronic message sent may indicate the probable cause (i.e., code error or data error) to jumpstart the troubleshooting process.

Numerous additional embodiments exist. For example, the exception analyzer may also analyze multiple exceptions received from multiple software versions of the same data ingest component to detect patterns over time (e.g., the multiple software versions of the data ingest component is associated with code error exceptions for an extended period of time). A reaction may then be chosen related to incorrect probable cause determination, such as ceasing to rollback the data ingest component to a prior software version when the next exception occurs, even if the probable cause of the exception is determined to be a code error.

### Example System

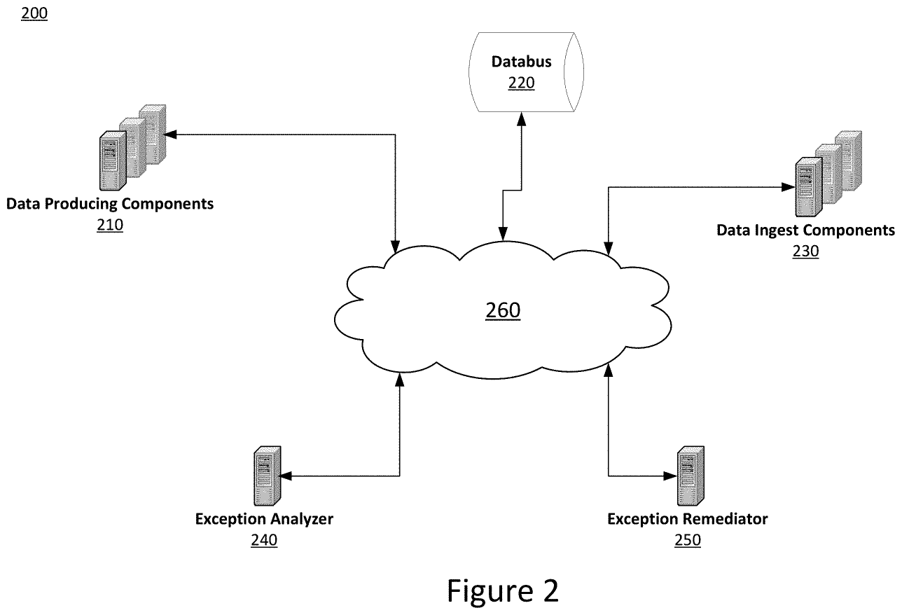

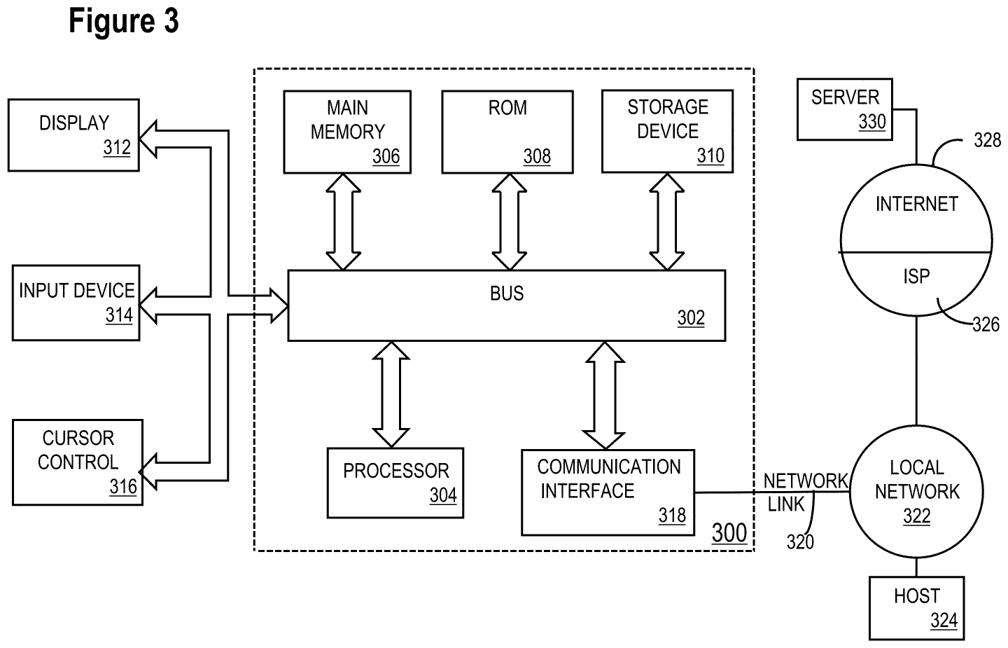

FIG. 2 depicts additional example systems for automatically reacting to data ingest exceptions in a data pipeline system based on determined probable cause of the exception. Data producing components 210, a databus 220, data ingest components 230, the exception analyzer 240, and the exception remediator 250 may all be coupled to a network 60 and be able to communicate via the network. Each of the data producing components 210, the databus 220, the data ingest components 230, the exception analyzer 240, and the exception remdiator 250 may run as part of the same process and or on the same hardware (not depicted in FIG. 2), or may run separately. Further, each may run on a single processor or computing device or on multiple computing devices, such as those discussed with respect to FIG. 3 and elsewhere herein.

As discussed elsewhere herein, the data producing components 210 may produce data for processing by the data ingest components 230. In this regard, the data producing components 210 may publish data messages to the databus 220 and the data ingest components 230 may subscribe to and consume published data messages from the databus 220. The databus 220 may store published data messages in volatile and/or non-volatile memory for a period of time (e.g., until they have been successfully processed by all data ingest components 230 that subscribe to the messages).

As discussed elsewhere herein, a data ingest component 230 (or the global exception handling portion thereof) may determine that an exception has occurred while processing (ingesting) a data message consumed from the database 220. The data ingest component 230 may, after determining that filtering criteria for the exception have been met, provide a notification of the exception to the exception analyzer 240. The exception analyzer 240 may analyze the notification obtained from the data ingest component 230 to determine a probable cause of the exception. Based on the analysis, the exception analyzer 240 may select and cause a reaction to the exception to be performed by the exception remediator 250. Numerous examples are given throughout herein, and as one example, the exception remediator 250 may revert the data ingest component 230 to a prior software version of the data ingest component 230 if the exception analyzer 240 determines that the probable cause of the exception is a code error in the current software version of the data ingest component 230.

As discussed herein, the process 100 may run in single or multiple instances, and run in parallel, in conjunction, together, or one process 100 may be a sub-process 100 of another process 100. Further, any of the processes discussed herein, including process 100 may run on the systems and hardware discussed herein, including those depicted in FIG. 2 and FIG. 3.

### Hardware Overview

According to some embodiments, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general-purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as an OLED, LED or cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane. The input device 314 may also have multiple input modalities, such as multiple 2-axes controllers, and/or input buttons or keyboard. This allows a user to input along more than two dimensions simultaneously and/or control the input of more than one type of action.

Computer system 300 may implement the techniques described herein using customized hard-wired logic, one or more ASICs or FPGAs, firmware and/or program logic which in combination with the computer system causes or programs computer system 300 to be a special-purpose machine. According to some embodiments, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a hard disk, solid-state drive, magnetic tape, or any other magnetic data storage medium, a CD-ROM, any other optical data storage medium, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be a modem to provide a data communication connection to a corresponding type of telephone or coaxial line. As another example, communication interface 318 may be a network card (e.g., an Ethernet card) to provide a data communication connection to a compatible Local Area Network (LAN). Wireless links may also be implemented. In any such implementation, communication interface 318 sends and receives electrical, electromagnetic or optical signals that carry digital data streams representing various types of information. Such a wireless link could be a Bluetooth, Bluetooth Low Energy (BLE), 802.11 WiFi connection, or the like.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world-wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

### EXTENSIONS AND ALTERNATIVES

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A computer-implemented method, comprising:
determining, at an exception handler in a data pipeline system comprising a plurality of data ingest components, whether filtering criteria have been met for providing a notification of a particular exception in a particular data ingest component to an exception analyzer, the exception handler executing using one or more computing devices and programmed to execute exception handling computer program instructions;
in response to determining that the filtering criteria for providing the notification of the particular exception to the exception analyzer is satisfied, providing the notification of the particular exception to the exception analyzer, the exception analyzer executing using one or more computing devices and programmed to execute exception analyzing computer program instructions;
obtaining, at the exception analyzer, the notification of the particular exception;
in response to obtaining the notification of the particular exception, analyzing, at the exception analyzer, the notification of the particular exception and selecting a first reaction for an exception remediator to perform to attempt to recover from the particular exception, the selecting the first reaction based on the analyzing the notification of the particular exception, the exception remediator executing using one or more computing devices and programmed to execute exception remediation computer program instructions; and
performing, at the exception remediator, the first reaction in response to the exception analyzer choosing the first reaction to perform to attempt to recover from the particular exception.

2. The computer-implemented method of claim 1, wherein the performing the first reaction is based on automatically rolling back the particular data ingest component to a prior known stable software version of the particular data ingest component.

3. The computer-implemented method of claim 1, wherein the performing the first reaction is based on creating a troubleshooting ticket for the particular exception in a troubleshooting ticketing system.

4. The computer-implemented method of claim 1, wherein the performing the first reaction is based on sending an electronic message about the particular exception to troubleshooting personnel.

5. The computer-implemented method of claim 1, wherein the determining that the filtering criteria for providing the notification of the particular exception to the exception analyzer is satisfied is based on determining that a number of exceptions have occurred in the particular data ingest component in a particular period of time.

6. The computer-implemented method of claim 1, wherein the notification of the particular exception comprises: an identifier of a type of the particular exception and an identifier of the particular data ingest component.

7. One or more non-transitory computer-readable media storing one or more programs for execution by one or more computing devices, the one or more programs comprising instructions configured for:
determining, at an exception handler in a data pipeline system comprising a plurality of data ingest components, whether filtering criteria have been met for providing a notification of a particular exception in a particular data ingest component to an exception analyzer;
in response to determining that the filtering criteria for providing the notification of the particular exception to the exception analyzer is satisfied, providing the notification of the particular exception to the exception analyzer;
obtaining, at the exception analyzer, the notification of the particular exception;
in response to obtaining the notification of the particular exception, analyzing, at the exception analyzer, the notification of the particular exception and selecting a first reaction for an exception remediator to perform to attempt to recover from the particular exception, the selecting the first reaction based on the analyzing the notification of the particular exception; and
performing, at the exception remediator, the first reaction in response to the exception analyzer choosing the first reaction to perform to attempt to recover from the particular exception.

8. The one or more non-transitory computer-readable media of claim 7, wherein the analyzing the notification of the particular exception is based on determining a probable cause of the particular exception; and wherein the selecting the first reaction is based on the probable cause.

9. The one or more non-transitory computer-readable media of claim 7, wherein the probable cause is a code error in the particular data ingest component; and wherein the selecting the first reaction is based on the probable cause being the code error.

10. The one or more non-transitory computer-readable media of claim 7, wherein the probable cause is a data error in data being ingested by the particular data ingest component when the particular exception occurred; and wherein the selecting the first reaction is based on the probable cause being the data error.

11. The one or more non-transitory computer-readable media of claim 7, wherein the notification of the particular exception comprises: an identifier of a type of the particular exception and an identifier of a particular data producing component that produced data being ingested by the particular data ingest component when the particular exception occurred.

12. The one or more non-transitory computer-readable media of claim 7, wherein the performing the first reaction is based on automatically reverting the particular data ingest component to a prior known stable software version of the particular data ingest component.

13. The one or more non-transitory computer-readable media of claim 7, wherein the performing the first reaction is based on automatically creating a troubleshooting ticket for the particular exception in a troubleshooting ticketing system.

14. The one or more non-transitory computer-readable media of claim 7, wherein the performing the first reaction is based on automatically sending an electronic message about the particular exception to troubleshooting personnel.

15. The one or more non-transitory computer-readable media of claim 7, wherein the determining that the filtering criteria for providing the notification of the particular exception to the exception analyzer is satisfied is based on determining that a number of exceptions that have occurred in the particular data ingest component in a particular period of time exceeds a threshold.

16. A computing system comprising:
one or more processors;
one or more programs including a data ingest program, an exception analyzer program, and an exception remediator program, the data ingest program having an application sub-component and an exception handling sub-component; and
storage media storing the one or more programs configured for execution by the one or more processors;
wherein the exception handling sub-component is configured to determine that a particular exception has occurred in an executing instance of the data ingest program and configured to determine filtering criteria have been met for providing a notification of the particular exception to an executing instance of the exception analyzer program;
wherein the exception handling component is configured to provide the notification of the particular exception to the executing instance of the exception analyzer program in response to determining that the filtering criteria is satisfied;
wherein the exception analyzer program is configured to analyze the notification of the particular exception to select a first reaction for an executing instance of the exception remediator program to perform to attempt to recover from the particular exception; and
wherein the exception remediator program is configured to perform the first reaction.

17. The computing system of claim 16, wherein the exception remediator program is configured to perform the first reaction by automatically rolling back the application sub-component of the data ingest program to a prior known stable software version of the application sub-component.

18. The computing system of claim 16, wherein the exception analyzer program is configured to determine a probable cause of the particular exception.

19. The computing system of claim 18, wherein the exception analyzer program is configured to determine the probable cause of the particular exception by classifying the particular exception into one of at least two classes according to a trained multinomial logistic regression model.

20. The computing system of claim 19, wherein the at least two classes include code error probable cause and data error probable cause.
